(19) United States
(12) Patent Application Publication
(10) Pub. No.: US 2022/0178100 A1
(43) Pub. Date: Jun. 9, 2022

(54) BREAKWATER

(71) Applicant: Yves Joseph Guy De Leeneer, Singapore (SG)

(72) Inventor: Yves Joseph Guy De Leeneer, Singapore (SG)

(21) Appl. No.: 17/603,888

(22) PCT Filed: Apr. 15, 2020
(86) PCT No.: PCT/EP2020/060604

§ 371 Date: Oct. 14, 2021

(30) Foreign Application Priority Data
Apr. 16, 2019 (GB) 1905368.5

(51) Int. Cl. E02B 3/06

(52) U.S. Cl. CPC E02B 3/06; E02B 3/046

(57) ABSTRACT

A breakwater comprising a base member having an outer surface, and a plurality of elongate members is disclosed. An end region of each of the plurality of elongate members is coupled to the outer surface of the base member. The base member and/or at least one of the elongate members has a textured surface for the attachment of marine life. The breakwater may be located on a seabed, a riverbed, an ocean floor or a floor of a waterway, to protect a coast or riverbank from coastal erosion.

### TECHNICAL FIELD

The present disclosure relates to breakwaters, in particular, but not exclusively to submerged breakwaters.

### BACKGROUND

Coastal erosion, the removal of material from a coast, is a continuous process that is primarily caused by wave action and tidal (and other) currents. Generally, breakwaters are constructed along a coast to reduce or prevent coastal erosion. Breakwaters attenuate energy of waves and currents reaching the coast, subsequently protecting the coast from erosion.

However, breakwaters generally reflect and diffract energy from waves, rather than letting some wave energy through and reflecting and absorbing some wave energy, causing erosion elsewhere. Further, breakwaters typically appear above the surface of the water, causing an aesthetically displeasing sight on the shoreline. Submerged breakwaters attenuate wave energy reaching a coast without affecting the view of the shoreline. They can also act as artificial reefs to provide a habitat for fish, coral, plankton, kelp and other marine life. However, submerged breakwaters such as Reef Balls have limited surface area available for marine life to grow on. Further, they are generally not secured to the seabed and can therefore be dislocated from their intended location and orientation due to the effect of waves and currents.

Another form of erosion is hydrodynamic scour, the removal of sediment such as silt, sand and gravel from around the base of obstructions to water flow in the sea, rivers and canals such as the support structures of piers and bridges. This removal of sediment can cause scour holes to be formed, which often result in a lack of stability of the support structures and can ultimately lead to the failure of the foundations of the support structures and the bridge or pier itself.

The present disclosure has been devised to mitigate or overcome at least some of the above-mentioned problems.

### SUMMARY

According to an aspect of the disclosure, there is provided a breakwater comprising a base member having an outer surface, and a plurality of elongate members. An end region of each of the plurality of elongate members is coupled to the outer surface of the base member. The base member and/or at least one of the elongate members has a textured surface for the attachment of marine life.

When in use, the breakwater may be located on a seabed, a riverbed, an ocean floor or a floor of a waterway, to protect a coast or riverbank from coastal erosion. The breakwater can also be used to protect offshore structures such as oil rigs, subsea structures, offshore wind turbine monopiles, piles and towers, as well as the support structures of piers and bridges from hydrodynamic scour. The breakwater induces a reduction in water velocity and water celerity, and creates a turbulent flow in water passing around and through the breakwater. The reduced water velocity and celerity and the turbulent flow leads to a reduction in the speed and energy of the water flow around the breakwater, thereby attenuating wave energy that would otherwise cause erosion. The attenuation of wave energy also aids the prevention and reversal of hydrodynamic scour by slowing down water flow around the breakwater, enabling sediment and soil deposition in the lee of the breakwater. This can provide additional sediment to build up to the seabed surrounding the breakwater.

The breakwater provides a substrate and habitat for marine life such as coral and kelp, the growth of which can compensate for wear-and-tear of the breakwater such that the breakwater may not need to be replaced. Advantageously, the elongated members of the breakwater may increase the surface area of the breakwater by at least 300 times that of the surface area of the base member alone. This substantially increases the substrate surface area available on which marine life can grow. This increased surface area acts to accelerate the rate at which the breakwater may be covered in marine life, as well as increasing the amount of marine life that can grow on the breakwater. The increased amount of marine life and increased rate of coverage by marine life may increase the longevity of the breakwater, for example by compensating for wear-and-tear. Accordingly, the (man-made) breakwater may become an integral part of the marine subsea life, so that decades after being installed, the breakwater may be completely over taken by the marine life, and a new coral reef or marine structure may be formed which can then continue to grow. The (man-made) breakwater thus becomes a reef forming a natural breakwater. This creates long term changes in the marine subsea lay-out and permanent protection against erosion.

The elongate members radiating outward from the base member of the breakwater may increase the effective substrate area and volume occupied by the breakwater whilst minimising the amount of material required, such as concrete, to provide a structure able to withstand storms and ocean currents. The increased amount of marine life and increased rate of coverage by marine life enabled by the increased surface area of the plurality of elongate members may increase the stability of the breakwater, for example as marine life may act to anchor the breakwater to the seabed as well as increasing the effective mass of the breakwater. The breakwater may be fully or partially submerged in use. For example, a portion of the breakwater may not be submerged during low tide, but the breakwater may be fully submerged during high tide. In other applications, a portion of the breakwater may permanently be above the surface of the water.

The base member may be solid or hollow. Beneficially, a hollow base member provides a shelter inside for marine life. A solid base member has more weight than a hollow base member of the same size, making a solid base member more resistant to movement by sliding or overturning. The base member may have a width of 1 to 10 metres, and a length of 1 to 20 metres, preferably 2 metres for ease of fabrication and handling and transport. Hollow base members may have a wall thickness of 0.1 to 1 metres.

The base member may have a cylindrical shape, or a prism having a regular or irregular polygonal cross section, for example, triangular, rectangular, hexagonal, octagonal, or decagonal cross sections. Advantageously, a triangular cross section provides stability for the base member on the seabed (or riverbed). In some embodiments, the shape of the base is, for example, a pyramid, a flat-bottomed ovoid, a frustum, or a dodecahedron.

Optionally, a plurality of flanges adjoin an edge of the base member, spaced apart from each other. The plurality of flanges are arranged to interlock with a corresponding plurality of flanges on an edge of another base member and enable a secure connection between base members. For example, the plurality of flanges may be a plurality of chevrons, each chevron having a triangular or trapezoidal shape and a base which adjoins the edge of the base member. In other examples, the plurality of flanges may each have a rectangular shape. The plurality of flanges may be attached to or integrally formed with the base member. A plurality of breakwaters can be arranged to protect a coast or offshore structure, either spaced apart from each other or connected to each other, for example by interlocking flanges.

The base member may be comprised of one or more of concrete, metal, plastic such as polyethylene, wood, and bamboo. Optionally, the surface of the base member is textured, rather than smooth, to encourage attachment of marine life.

The end region of an elongate member may include a region proximate to an end of the elongate member and/or the end of the elongate member. The elongate member may be coupled to the outer surface of the base member by using glue and/or fastening means such as bolts and nuts, screws and/or nails. Coupling between the elongate members and base member may be through flanges on the elongate members, and/or quick connect-disconnect systems. The base member may comprise a plurality of recesses into which respective elongate members are inserted for coupling. Additionally or alternatively, the base member may comprise a plurality of protrusions which may be each be inserted into respective hollow or partially-hollow elongate members for coupling.

One or more of the plurality of elongate members may be solid or hollow. Beneficially, a hollow elongate member provides shelter inside for marine life. One or more of the plurality of elongate members may have a width of 0.1 to 1 metres, and a length of 0.5 to 20 metres. In other words, the elongate members on a base member may have different widths and lengths. Hollow elongate members may have a wall thickness of 0.01 to 0.5 metres.

One or more of the plurality of elongate members may have a circular cross section, or a regular or irregular polygonal cross section, for example, triangular, rectangular, hexagonal, octagonal, or decagonal cross sections.

One or more of the plurality of elongate members may be comprised of one or more of concrete, metal, plastic such as polyethylene, wood, and bamboo. Optionally, the surface of one or more of the plurality of elongate members is textured, rather than smooth, to encourage attachment of marine life.

The plurality of elongate members may be integrally (ie monolithically) formed with the base member. For example, a base member and its plurality of elongate members may be cast together in plastic, metal or concrete, or fabricated from a single piece of wood or bamboo.

When the base member is hollow, the base member optionally comprises a plurality of apertures in the outer surface. These apertures enable marine life to pass into the centre of the base member for shelter. At least one of the plurality of elongate members may extend through a respective one of the plurality of apertures in the outer surface. There may be more apertures than elongate members such that even when all elongate members extend through a respective aperture, the base member comprises apertures that do not have an elongate member. Alternatively or additionally to fastening means, the coupling between the elongate members and the base member may be through an interference fit between an aperture of the base member and an end region of an elongate member. One or more of the elongate members may pass into the hollow centre of the base member.

When the base member is solid or hollow, the base member optionally comprises a plurality of recesses in the outer surface. At least one of the plurality of elongate members may extend into a respective one of the plurality of recesses in the outer surface. There may be more recesses than elongate members such that even when all elongate members extend into a respective recess, the base member comprises recesses that do not have an elongate member. Alternatively or additionally to fastening means, the coupling between the elongate members and the base member may be through an interference fit between an recess of the base member and an end region of an elongate member. These recesses may provide shelter for marine life.

Optionally, the plurality of elongate members are arranged in a plurality of rows along a length of the case member, a row being formed by at least two elongate members. A width of the elongate members in adjacent rows may be different.

Optionally, the outer surface of the base member comprises a first portion and a second portion. The plurality of elongate members may be coupled to the first portion, and no elongate members may be coupled to the second portion. For example, the second portion is a portion that would rest against the seabed or riverbed, and so it may be less desirable to have elongate members on the seabed or riverbed side of the base member. One or more of the elongate members on the first portion that are adjacent to the second portion may be stronger than other elongate members. Elongate members adjacent the second portion may rest against the seabed or riverbed, and so stronger elongate members adjacent the second portion advantageously act to anchor the breakwater and support it against lateral, longitudinal, twisting and overturning loads caused by waves and currents. For example, the stronger elongate members may wider, solid, and/or comprise a stronger material than other elongate members.

### BRIEF DESCRIPTION OF THE DRAWINGS

Further details, aspects and embodiments of the disclosure will be described, by way of example only, with reference to the drawings in which:

FIG. 1(a) shows a front view of a breakwater having a base member and a plurality of elongate members;

FIG. 1(b) shows a side view of the breakwater of FIG. 1(a);

FIG. 2 shows a front view of the base member of FIGS. 1(a) and 1(b);

FIG. 3 shows wave attenuation of the breakwater of FIGS. 1(a) and 1(b);

FIG. 4 shows a front view of a breakwater;

FIG. 5 shows a front view of a breakwater;

FIG. 6(a) shows a top view of a breakwater having a base member and a plurality of elongate members;

FIG. 6(b) shows a side view of the breakwater of FIG. 6(a);

FIG. 7(a) shows an anchor for the breakwater of FIGS. 6(a) and 6(b); and

FIG. 7(b) shows the base member of the breakwater of FIGS. 6(a) and 6(b) installed on the anchor of FIG. 7(a).

Elements in the figures are illustrated for simplicity and clarity and have not necessarily been drawn to scale. Like reference numerals have been included in the respective drawings to ease understanding.

### DETAILED DESCRIPTION OF THE DRAWINGS

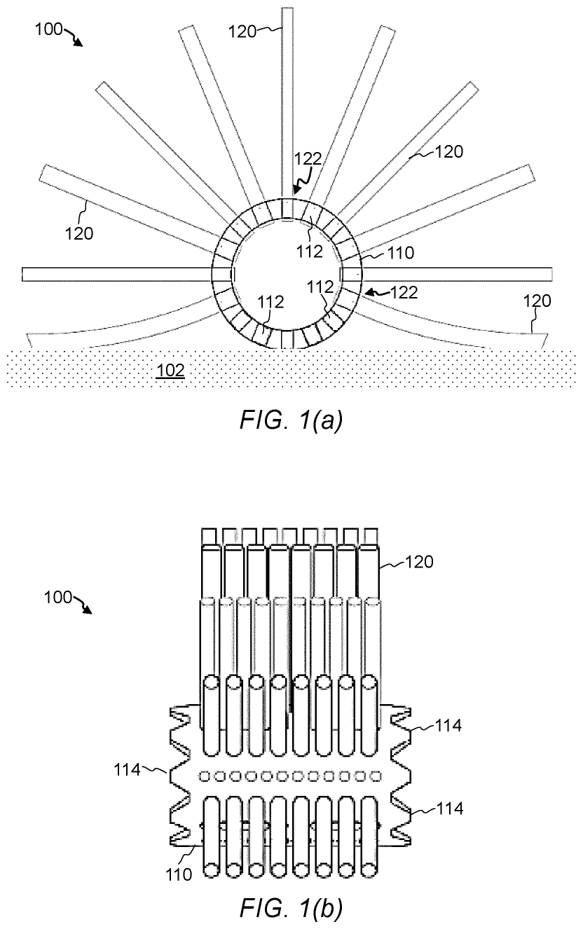

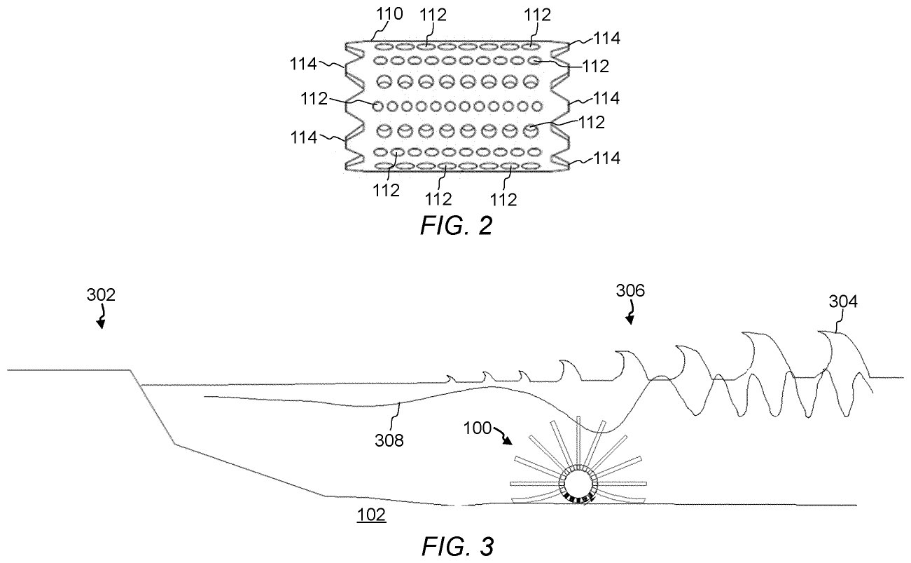

With reference to FIGS. 1(a), 1(b) and 2, a breakwater 100 is arranged on a seabed 102. The breakwater 100 comprises a base member 110 and a plurality of elongate members 120. The base member 110 is tubular and has a circular cross section. In other examples, the cross section of the breakwater may be a prism having a regular or irregular polygonal cross section such as triangle, rectangle, hexagon, octagon, or decagon.

The base member 110 comprises a plurality of apertures 112 in its outer surface, ie through the wall of the base member, and a plurality of flanges 114 adjoining the edges of the base member 110. The plurality of flanges 114 may be attached to or integrally formed with the base member 110. In some examples, the breakwater may not comprise flanges 114. The flanges 114 are spaced out around the edges of the base member 110 and each have a trapezoidal shape. In other examples, the flanges may have a triangular or rectangular shape. The spacing and shape of the flanges 114 is arranged such that the trapezoidal shapes tessellate with corresponding flanges on another base member, enabling the base members to interlock with each other.

Each of the plurality of elongate members 120 is tubular and has a circular cross section. The breakwater 100 comprises five different diameters of elongate member. In other examples, the cross section of the plurality of elongate members may be a prism having a regular or irregular polygonal cross section such as triangle, rectangle, hexagon, octagon, or decagon. In other examples, the diameters of all the elongate members may be the same, or there may be a plurality of different diameters of the elongate members on the breakwater.

An end region 122 of each elongate member 120 is coupled to the base member 110 on a portion of the base member 110. The coupling between each end region 122 and the base member 110 may be use fasteners and/or through an interference fit (ie friction fit) between the outer diameter of the elongate member and the inner diameter of the respective aperture. A portion of one or more of the elongate members 120 may pass into the hollow centre of the base member 110.

The portion of the base member 110 to which the elongate members 120 are coupled is not near the seabed 102 so that the base member 110 sits directly on the seabed 102. The end region 122 of each elongate member 120 is located in a respective aperture 112. The elongate members 120 closest to the seabed 102 contact the seabed 102 thereby anchoring the breakwater 100. In addition, the base member 110 may be secured to the seabed 102 using anchoring means such as piles, pitons, chains, or anchors.

The base member 110 and the elongate members 120 may be comprised of one or more of concrete, metal, plastic such as polyethylene, wood, and bamboo. The surface of the base members and the elongate members may be textured, rather than smooth, to encourage attachment of marine life.

With reference to FIG. 3, in use, the breakwater 100 is submerged near a coast 302 to protect the coast 302 from approaching waves by attenuating energy of the waves. A wave 304 approaches the coast 302 and as it approaches the breakwater 100, the wave crests reduce in region 306 due to absorption and reflection of the energy of the wave 304 by the breakwater 100. Energy and velocity of the wave 304 has an effect below the surface, and a subsurface part 308 of the wave 304 contacts the breakwater 100, causing turbulent flow and dispersal of the energy of the subsurface part 308. As a result, only a fraction of the energy of the wave 304 reaches the coast 302. The wave energy may be attenuated from 20% to 90% with a corresponding loss in wave height by 20% to 60% depending on the depth of the water.

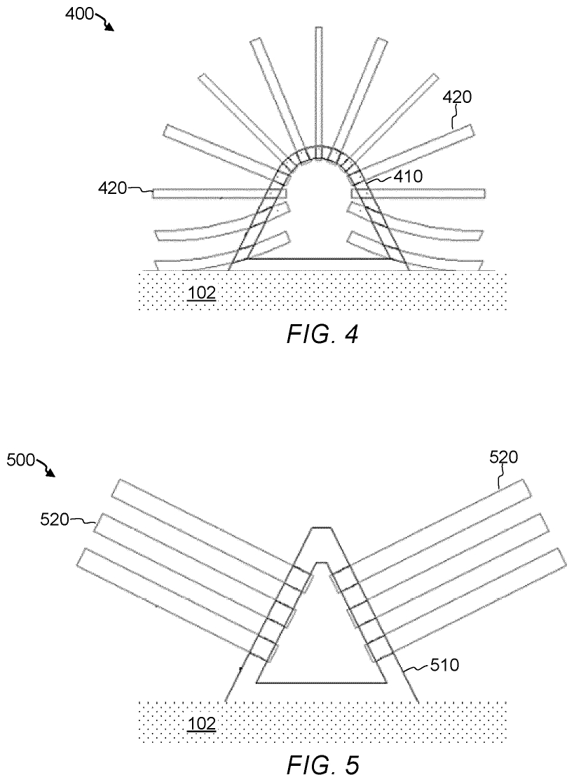

With reference to FIG. 4, a breakwater 400 is arranged on a seabed 102. The breakwater 400 comprises a base member 410 and a plurality of elongate members 420. The breakwater 400 is substantially the same as the breakwater 100. However, the base member 410 of the breakwater 400 is a hollow prism with a substantially triangular cross section with a rounded upper vertex. The breakwater 400 may also comprise flanges on the edges of the base member 410 similar to the breakwater 100.

With reference to FIG. 5, a breakwater 500 is arranged on a seabed 102. The breakwater 500 comprises a base member 510 and a plurality of elongate members 520. The breakwater 500 is substantially the same as the breakwater 100. However, the base member 510 of the breakwater 500 is a hollow prism with a triangular cross section. The breakwater 500 may also comprise flanges on the edges of the base member 510 similar to the breakwater 100.

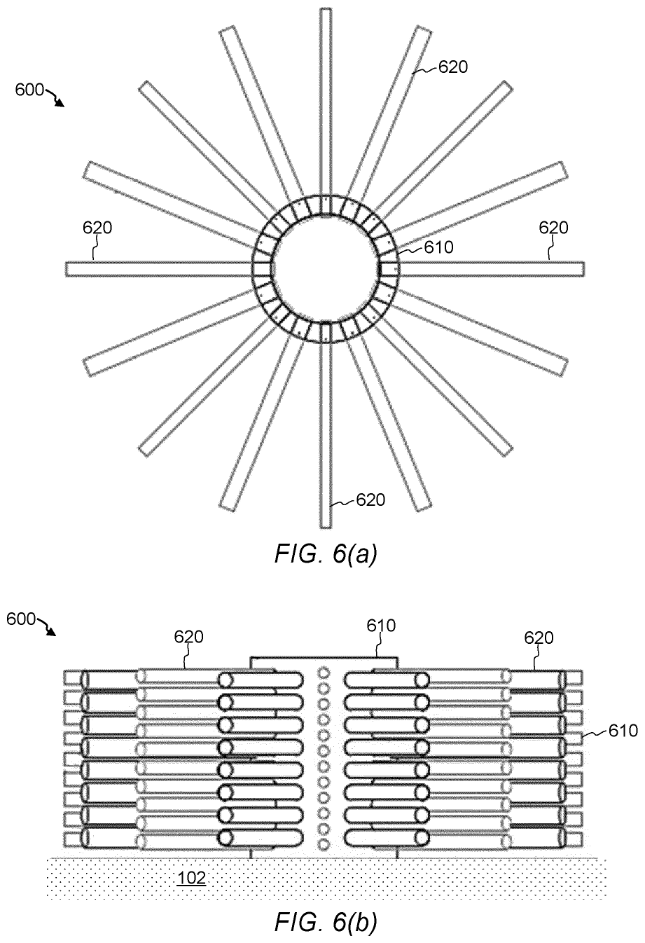

With reference to FIGS. 6(a) and 6(b), a breakwater 600 is arranged on a seabed 102. The breakwater 600 comprises a base member 610 and a plurality of elongate members 620. The breakwater 600 is substantially the same as the breakwater 100. However, the breakwater 600 is arranged to rest of the seabed 102 on an edge of the base member 610 and accordingly, the base member 610 of the breakwater 600 does not have flanges for interlocking with other breakwaters. In some examples, the base member 610 may comprise flanges on its edges, for example on the edge resting on the seabed 102, to provide a more secure foundation with the seabed.

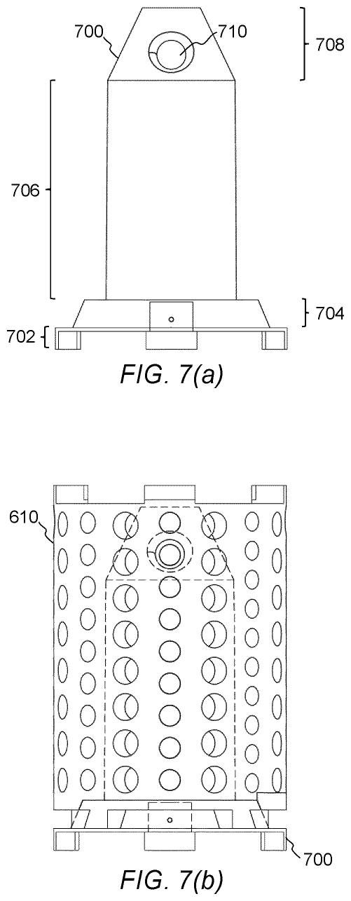

With reference to FIGS. 7(a) and 7(b), an anchor 700 for the breakwater 600 comprises a base portion 702, a lower middle portion 704, an upper middle portion 706 and a top portion 708. The anchor 700 is arranged to slot into the base member 610 of the breakwater 600, thereby securing it to the seabed. Note that in FIG. 7(b), the breakwater 600 is illustrated without the elongate member 620.

The base portion 702 is arranged to be fastened to the seabed and has a disc or ring shape with a diameter that is approximately the same as the outer diameter of the tubular base member 610. The base portion 702 also comprises feet for engagement with the seabed 102. The lower middle portion 704 has a frustoconical shape in which the largest diameter is substantially the same as the inner diameter of the tubular base member 610, in order to seat the base member 100 on the anchor 700. The upper middle portion 706 has a cylindrical shape with a diameter that is smaller than the inner diameter of the tubular base member 610. The top portion 708 has a frustoconical shape in which the largest diameter is the same as the diameter of the upper middle portion 706. The top portion comprises an aperture 710 in the side for engagement by a lifting hook. The base portion 702, the lower and upper middle portions 704, 706 and the top portion 708 are integrally formed, and are coaxial.

The base members and elongate members of breakwaters 100, 400, 500 and 600 are hollow but the skilled person would recognise that they may also be solid. The base members of breakwaters 100, 400, 500 and 600 may have a width of 1 to 10 metres, and a length of 1 to 20 metres. The width and length may be increased for applications where breakwaters are fabricated in long sections. Hollow base members may have a wall thickness of 0.1 to 1 metres. The plurality of elongate members of breakwaters 100, 400, 500 and 600 may have a diameter of 0.1 to 1 metres, and a length of 0.5 to 20 metres. In other words, the elongate members on a base member may have different widths and lengths. Hollow elongate members may have a wall thickness of 0.01 to 0.5 metres.

The elongate members of breakwaters 100, 400, 500 and 600 are arranged in rows, but the skilled person would recognise that elongate members may be arranged in any pattern on a base member.

Breakwaters 100, 400, 500 and 600 are described as being arranged on a seabed 102 but the breakwaters 100, 400, 500 and 600 are also arrangeable on a riverbed, an ocean floor or a floor of a waterway in use.

Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Although the present disclosure has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ or “including” does not exclude the presence of other elements.

1. A breakwater comprising:
a base member having an outer surface; and
a plurality of elongate members, wherein an end region of each of the plurality of elongate members is coupled to the outer surface of the base member, wherein the base member and/or at least one of the elongate members has a textured surface for the attachment of marine life,
wherein a plurality of flanges adjoin an edge of the base member, wherein each of the plurality of flanges are spaced apart from each other.

2. The breakwater of claim 1, wherein the base member is hollow.

3. The breakwater of claim 2, wherein the base member comprises a plurality of apertures in the outer surface.

4. The breakwater of claim 3, wherein at least one of the elongate members extends through a respective one of the plurality of apertures in the outer surface.

5. The breakwater of claim 1, wherein at least one of the elongate members is hollow.

6. (canceled)

7. The breakwater of claim 1, wherein the plurality of flanges are a plurality of chevrons, each chevron having a triangular or trapezoidal shape and a base which adjoins the edge of the base member.

8. The breakwater of claim 1, wherein the plurality of elongate members are arranged in a plurality of rows along a length of the base member.

9. The breakwater of claim 8, wherein a width of the elongate members in adjacent rows are different.

10. The breakwater of claim 1, wherein the outer surface of the base member comprises a first portion and a second portion, and wherein the plurality of elongate members are coupled to the first portion, and no elongate members are coupled to the second portion.

11. The breakwater of claim 10, wherein at least one of the plurality of elongate members adjacent to the second portion is stronger than other elongate members.

12. The breakwater of claim 1, wherein the base member has a length of 1 to 20 meters.

13. The breakwater of claim 1, wherein the base member has a width of 1 to 10 meters.

14. The breakwater of claim 1, wherein one or more of the plurality of elongate members has a length of 0.5 to 20 meters.

15. The breakwater of claim 1, wherein one or more of the plurality of elongate members has a width of 0.1 to 1 meters.

16. The breakwater of claim 1, wherein the total surface area of the plurality of elongate members is at least 300 times that of the surface area of the base member.

17. The breakwater of claim 1, wherein the marine life compensates for wear-and-tear of the breakwater.
